(19) United States
(12) Patent Application Publication
(10) Pub. No.: US 2016/0313119 A1
(43) Pub. Date: Oct. 27, 2016

(54) FLEXIBLE STRAIGHTEDGE AND LEVEL

(71) Applicant: ROMAN DECORATING PRODUCTS LLC, CALUMET CITY, IL (US)

(72) Inventor: DENNIS SKRABAK, Dyer, IN (US)

(73) Assignee: ROMAN DECORATING PRODUCTS LLC, CALUMET CITY, IL (US)

(21) Appl. No.: 14/696,262

(22) Filed: Apr. 24, 2015

(51) Int. Cl. G01C 9/34

(52) U.S. Cl. CPC G01C 9/34

(57) ABSTRACT

A combination straightedge, ruler and leveling tool which contains both horizontal and vertical levels for use in various applications in home decorating and in the construction industry, wherein the combination straightedge, ruler and leveling unit is made of a rigid, but flexible material that can be rolled into a coil for a smaller storage footprint, and that can be unrolled for later use. The combination tool also has an optional hook and loop (such as “Velcro®” strips), or optional fasteners, snap buttons, or a string to keep it in a rolled configuration.

### FIELD OF INVENTION

The presently described invention relates generally to a flexible and collapsible straightedge and leveling device to be used in any application requiring a level or straightedge such as installing wallpaper, hanging pictures, posters, or other articles upon walls. More specifically it relates to the combination of the flexible straightedge with a level, which is a combined tool that is durable, not bulky, and is compact yet sturdy to fulfill the full functionality of a level and a straightedge.

### BACKGROUND

Levels have been part of the construction industry since the ancient times. The reed level was used by the ancient Arabs during construction of structures. Leveling devices are used to achieve a level position when hanging pictures, posters or other articles upon walls.

One type of leveling device is a bubble-within-fluid leveling device. This is generally termed a “spirit” level (or “bubble” level). The spirit level was invented by Melchisedech Thevenot in the 1600's. Typically, spirit levels comprise a transparent tubular vial that contains a predetermined quantity of fluid (such as a spirit or alcohol), leaving a bubble in the vial. Leveling devices generally comprise a body made of aluminum or metal that have various apertures and have tubular vials positioned within those apertures so that the leveling bubble in the tubular vial can be seen from the front or back of the leveling device.

Leveling devices are typically designed to indicate whether a surface is horizontal (level) or vertical (plumb). A spirit level is used to achieve a level position by aligning a straight edge of the level with an edge of the article, and adjusting the article's angle until the bubble is centered within the surrounding liquid. Different types of spirit levels may be used by carpenters, plumbers, electricians, handymen, stonemasons, bricklayers, other building trades workers, surveyors, millwrights and other metalworkers, and in some photographic or videographic work. Most leveling devices used in the construction industry are relatively large and expensive, are made of aluminum or metal, and are generally bulky.

More recently, leveling devices have incorporated use of a laser. These include manual-leveling lasers, self-leveling and automatic-leveling lasers, horizontal lasers, dual beam (or split-beam) lasers, line laser and rotary laser levels. These leveling devices are generally more expensive than traditional bubble-type lasers, and are bulkier and require charging or use of a battery.

A straightedge is a tool with an edge free from curves, or which is straight. It is used for transcribing straight lines, or checking the straightness of lines or edges. Some are combined with measurement indicia (or markings) to function as rulers or as measuring devices. Straightedges are generally used in the automotive service and machining industry to check the flatness of machined mating surfaces. They are also used as guides for installing wallpapers. True straightness can in some cases be checked by using a laser line level as an optical straightedge whereby it illuminates a straight line on a flat surface such as the edge of a plank or shelf. Straightedges which incorporate lasers are expensive. Moreover, to date, straightedges have been constructed of rigid (non-flexible) surfaces between one and four feet long and can be bulky and very heavy.

Collapsible or rollable tape measures have been used by seamstresses and other clothing designers to accurately measure the human form. However, the construction industry and consumers have not adapted the rollable tape measure for use as a straightedge as it is not able to maintain a straight edge without significant assistance. Moreover, collapsible or rollable tape measures simply do not provide the combined functionality of a leveling device.

Thus, a need exists for a device that combines the functionality of a straightedge and a level, including a straightedge with measurement indicia that allows it to also function as a ruler. There is a need for a compact, sturdy, lightweight, easy and inexpensive to manufacture, reusable and durable device that provides a combined functionality of a straightedge and a level, with the added functionality of a ruler.

### SUMMARY

The presently described invention relates generally to the combination of a collapsible straightedge, level, and ruler.

It is an object of the present invention to provide a single device that is capable of independently functioning as a straightedge, a level and/or a ruler.

It is also an object of the present invention to provide a device that has the combined features of a straightedge and level that is lightweight, compact, sturdy, easy and inexpensive to manufacture, reusable, and durable in its construction.

Other objects of the invention will be apparent hereinafter from the specification and from the recital of the appended claims, and when read in conjunction with the accompanying drawings.

The combination straightedge, ruler and level (“CSRL”) is developed for use in the installing of wallpaper, pictures and other home decor, but can be used in any application requiring a level, ruler or straightedge. While it is reusable, because of its low cost of manufacture, it may also be disposable. The CSRL can be used both in the vertical and horizontal position. The CSRL can also be rolled into a coil, which reduces storage space.

In an exemplary embodiment of the present invention, the straightedge is made of polystyrene, styrene, plastic or other materials known in the art which allow for the straightedge to retain its shape when rolled or folded. The straightedge is able to retain its rigidity when unfolded such that it does not need external assistance to operate as a straightedge (such as a hand to hold in place). The straightedge may include markings (or measurement indicia) on the top and bottom in equal increments which operate as a measuring device or ruler. The measurement indicia may also be on a front side and/or a back side of the straightedge. These markings or indicia can be either metric, US or other systems of measurement.

In this exemplary embodiment, the length of the CSRL can be three to four feet in length with a width of two and a half inches. The CSRL is of an operative thickness, but preferably 0.020 inches. The thickness of the CSRL can be varied depending upon the type of material used, so that it is rigid enough to function as a straightedge, yet foldable or rollable and able to retain its shape when rolled or folded. The length and width of the CSRL can also be varied.

The level portion of the CSRL is preferably of a bubble level variety. The leveling unit may be attached to the straight edge such as through adhesive or plastic riveting. The leveling unit is made of plastic or other lightweight material. The leveling unit is attached at one end of the CSRL, approximately one inch from the end, though it may be attached anywhere on the straightedge. The leveling unit itself preferably contains both “plumb” (90 degrees in the vertical direction) and “straight” (90 degrees in the horizontal direction) levels. The leveling unit that is used in an exemplary embodiment is approximately two inches in height and two and one quarter inches in length.

The CSRL is rollable and can be tucked into a relatively space for storage. In order to keep the CSRL rolled when not in use, it has an optional hook and loop (such as “Velcro®” strips). The CSRL can also be kept in its folded or rolled configuration using a string, or through fasteners such as but not limited to, clips and snap buttons.

In an another exemplary embodiment, each end of the CSRL has a punched hole (approximately one-eighth inch in diameter) located at a position that is horizontally aligned with the center of the leveling unit.

Additional features and embodiments of the systems will be described hereinafter and will form the inventive subject matter supporting the claims appended hereto. In this respect, before explaining at least one embodiment of the invention in detail, it is to be understood that the systems are not limited in application to the details of construction or to the arrangements of the components set forth in the following description or illustrated in the drawings. Rather, the systems may be practiced in numerous forms and embodiments, and of being practiced and carried out in various ways, all within the scope of the present inventions. Also, it is to be understood that the phraseology and terminology employed herein are for the purpose of the description and should not be regarded as limiting.

These and other embodiments, features, aspects, and advantages of the inventive systems will become better understood with regard to the following description, appended claims and accompanying drawings.

### BRIEF DESCRIPTION OF THE DRAWINGS

The foregoing aspects and the attendant advantages of the present invention will become more readily appreciated by reference to the following detailed description, and when taken in conjunction with the accompanying drawings, wherein:

FIG. 1 is front plan view of portions of the CSRL according to one embodiment of the present invention, with a break about the middle represented by a zig-zag line.

FIG. 2 is a perspective view of the CSRL as it appears when in its rolled or folded configuration.

FIG. 3 is a front plan view of the CSRL as it appears when used in the vertical position.

FIG. 4 is a front plan view of the CSRL as it appears when used in the horizontal position.

FIG. 5 is a top view of the CSRL as it appears when held in place in its rolled or folded configuration.

FIG. 6 is a front plan view of an embodiment of the CSRL with the measurement indicia on a top portion of the CSRL.

FIG. 7 is a front plan view of an embodiment of the CSRL with the measurement indicia on both the top portion and bottom portion of the CSRL.

### DETAILED DESCRIPTION

The presently described invention relates generally to the combination of a collapsible straightedge, level, and ruler.

The CSRL is developed for use in the installing of wallpaper, pictures and other home decor, but can be used in any home application requiring a level, ruler or straightedge. The low cost provides near throwaway functionality. The CSRL can be used both in the vertical and horizontal position. The CSRL can also be rolled into a coil, which reduces the space required to store a device which has the combined features of a straightedge, level and ruler.

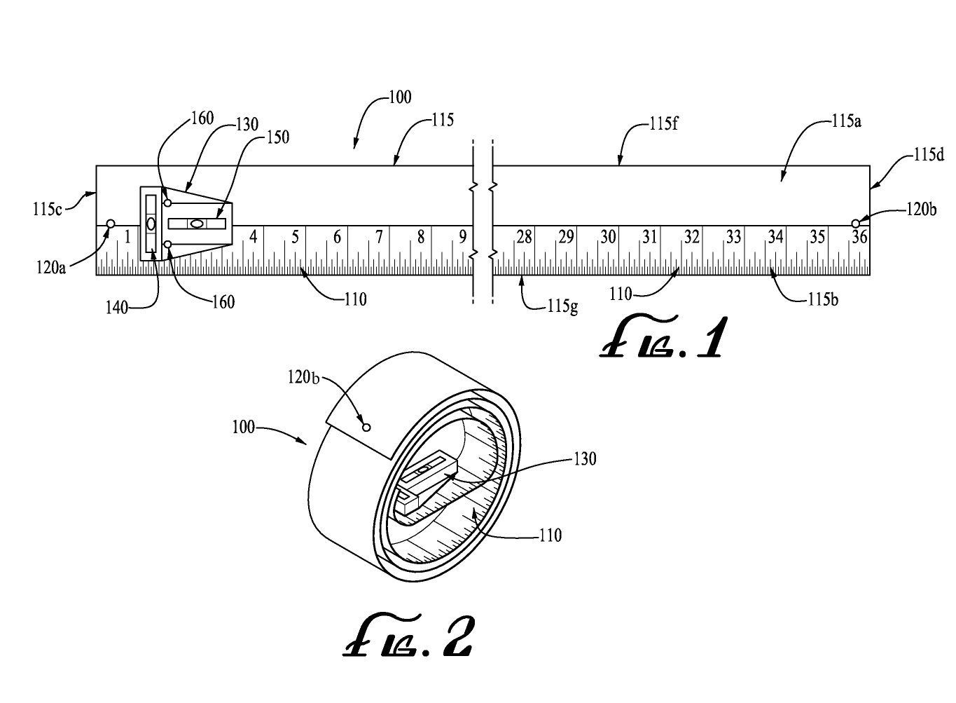

FIG. 1 is front plan view of an exemplary embodiment of the CSRL (100) showing the placement of the leveling unit (130), with a break about the middle represented by a zig-zag line. The portion represented by this zig-zag line is a uniform portion of a straightedge (115).

The CSRL depicted in FIG. 1 comprises a straightedge (115) and a leveling unit (130). In an exemplary embodiment, the CSRL may be three to four feet in length with a width of two and a half inches. The length and width of the CSRL can be varied. The CSRL is of a predetermined, operative thickness to allow flexibility (and capability to be rolled) yet rigidity such that the CSRL is independently capable of operating as a straightedge. For example, a thickness of 0.020 inches of a styrene material, allows such capability.

Referring to FIG. 1, the leveling unit (130) of the CSRL may comprise a combination of a vertical level (140), a horizontal level (150). The leveling unit (130) is preferably of a bubble level variety. The leveling unit (130) is preferably made of plastic or other lightweight material. The leveling unit (130) may be attached to the surface of the straightedge through either an adhesive (such as but not limited to thermal set adhesive) or through rivets (160) (such as but not limited to brass or plastic rivets), to secure the leveling unit (130) to the CSRL (100). The leveling unit (130) is attached to the surface of the straightedge, to allow vertical and/or horizontal leveling. In an exemplary embodiment such as shown in FIG. 1, the vertical level (140) is aligned with, or parallel to, the left vertical edge (115c) and the right vertical edge (115d) of the straightedge (115). The horizontal level (150) is aligned with, or parallel to, the top horizontal edge (115f) and the bottom horizontal edge (115g) of the straightedge (115).

The leveling unit (130) preferably contains both “plumb” (90 degrees in the vertical direction) and “straight” (90 degrees in the horizontal direction) levels. The leveling unit incorporated into the straightedge may be sourced from manufacturers such as Guangzhou Youcheng Hardware Co., Ltd., of Xingang Zhonglu, Guangzhou, China.

The straightedge (115) is made of styrene, polystyrene, plastic or other materials known in the art which allow for the straightedge to retain its shape when rolled or folded. The straightedge is able to retain its rigidity when unfolded as shown in FIG. 1 such that it does not need external assistance to operate as a straightedge.

As shown in FIG. 1, the straightedge (115) also has measuring indicia or units (110) printed on the straightedge's surface. The straightedge (115) has a top portion (115a) and a bottom portion (115b), and the straightedge (115) may include the markings (or measurement indicia) on the top portion (115a) and/or the bottom portion (115b) in equal increments which operate as a measuring device or ruler. The measurement indicia or units (110) may also be on a front side and/or a back side of the straightedge (115). The straightedge (115) may be opaque, translucent, or transparent. These markings or indicia can be either metric, US or other systems of measurement.

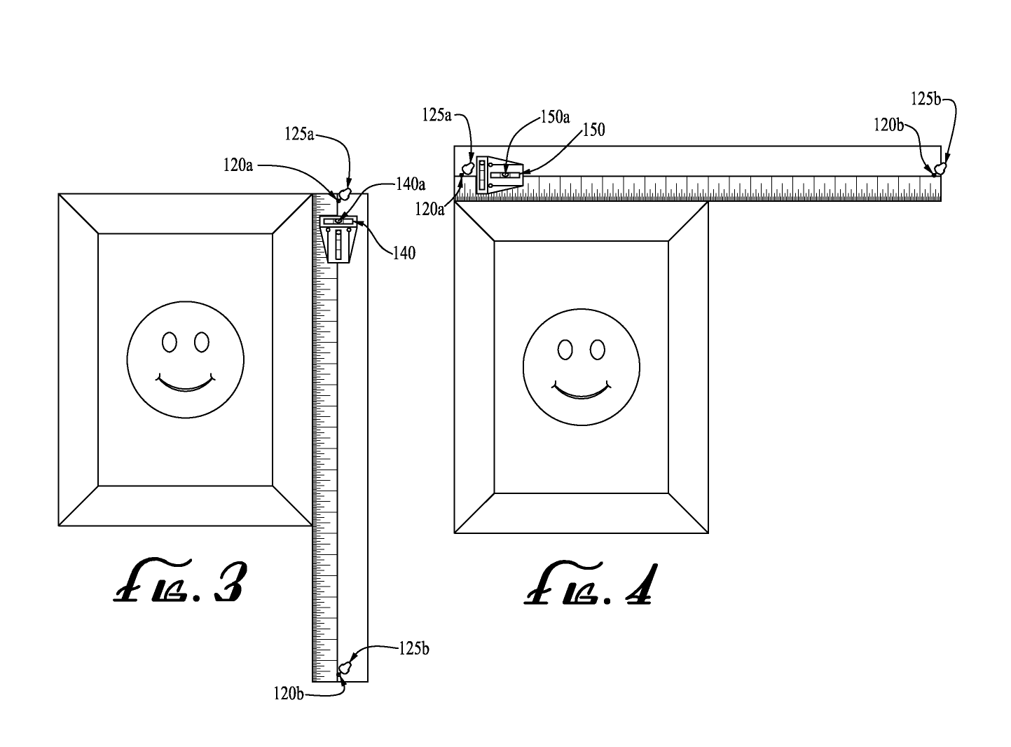

The straightedge (115) also has punched holes (120a and 120b). As shown in FIGS. 3 and 4, and as discussed below, pins (125a and 125b) may be placed into these punched holes (120a and 120b) to secure the CSRL (100) in place while in operation. Commercially-available pins or thumb tacks may be used. In an exemplary embodiment depicted in FIG. 1, the straightedge (115) has a first punched hole (120a) and a second punched hole (120b), each approximately one eighth inch in diameter. The first punched hole (120a) may be located proximal to the left vertical edge (115c) and the second punched hole (120b) may be located proximal to the right vertical edge (115d) of the straightedge. In an embodiment wherein the straightedge (115) is approximately two and a half inches in width, each punched hole is centered at approximately one and one fourth inches from the straightedge's top horizontal edge (115f) and one and one forth inches from the straightedge's bottom horizontal edge (115g). Preferably, as shown in FIG. 1, each punched hole (120a and 120b) is located at a position that is horizontally aligned with the center of the leveling unit (130).

FIG. 2 is a perspective view of the CSRL (100) as it appears when in its rolled or folded configuration. Preferably, the leveling unit (130) is located on the inside of the roll to protect the leveling unit.

FIG. 3 is a view of the CSRL (100) as it appears when used in the vertical position with the leveling unit (130) and punched holes (120a and 120b) in use when securing the CSRL (100) to a surface.

As shown in FIG. 3, the CSRL (100) is placed in a vertical position, for example, at the point where a first piece of wallpaper would be applied. A first pin (125a) is then inserted into a first punched hole (120a). After the first pin (125a) is inserted, the straightedge (115) is then adjusted to the left or to the right. Once the bubble (140a) in the plumb or vertical level (140) of the leveling unit (130) is centered, a second pin (125b) is then inserted into a second punched hole (120b). A pencil or other marker may then be used to draw a vertical line from top to bottom, or vice versa, using the straightedge (115) as a guide.

FIG. 4 is a front plan view of the CSRL (100) as it appears when used in the horizontal position with the leveling unit (130) and punched holes (120a and 120b) in use when securing the CSRL (100) to a surface.

As shown in FIG. 4, the CSRL (100) is placed in a horizontal position. A first pin (125a) is then inserted into a first punched hole (120a). After the first pin (125a) is inserted, the straightedge (115) is then adjusted upwards or downwards. Once the bubble (150a) in the horizontal level (150) of the leveling unit (130) is centered, a second pin (125b) is then inserted into a second punched hole (120b). A pencil or other marker may then be used to draw a horizontal line from left to right, or vice versa, using the straightedge (115) as a guide.

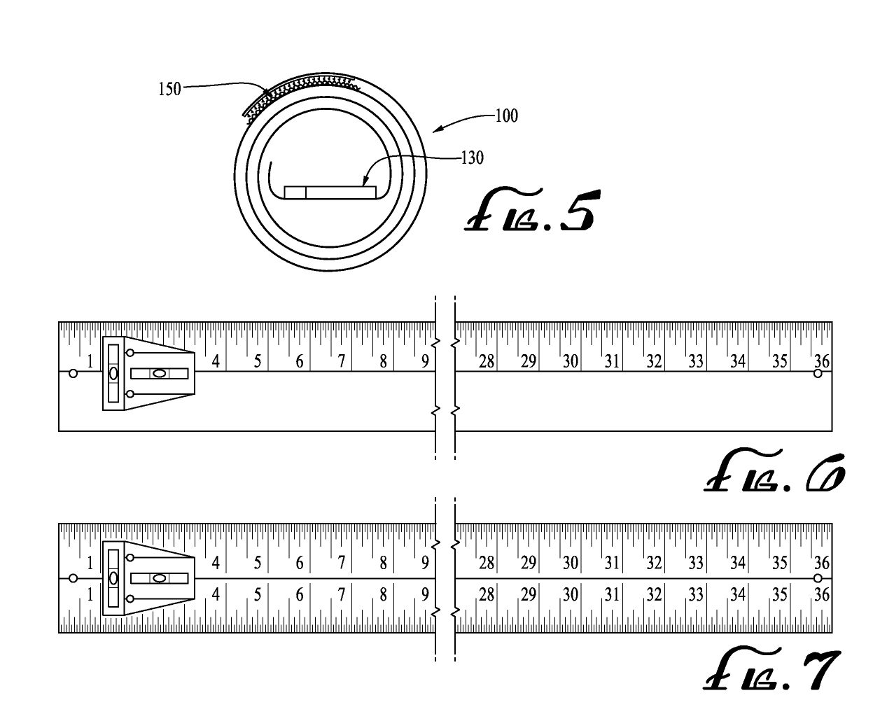

FIG. 5 is a top view of the CSRL (100) as it appears when held in place in its rolled or folded configuration when not in use, with the leveling unit (130) preferably on the inside of the roll. The CSRL is rollable and can be tucked into a relatively space for storage. In order to keep the CSRL rolled when not in use, it has an optional hook and loop, such as but not limited to, “Velcro®” attachments (500) shown in FIG. 5. A piece of fabric with “Velcro®” strips that is looped around the rolled CSRL, or Velcro® strips attached to the surface of the straightedge may also be used to keep the CSRL in its rolled configuration. The CSRL (100) can also be removably kept in its folded or rolled configuration with a string or using various fastening means such as but not limited to, snap buttons or clips, or by any other means known in the art to prevent the CSRL (100) from unfolding as shown in FIG. 1.

FIG. 6 is a front plan view of another embodiment of the CSRL with the measurement indicia on the top portion of the CSRL.

FIG. 7 is a front plan view of another embodiment of the CSRL with the measurement indicia on both the top portion and bottom portion of the CSRL.

Although specific embodiments of the CSRL have been described, various modifications, alterations, alternative constructions, and equivalents are also encompassed within the scope of these inventions.

The specification and figures are, accordingly, to be regarded in an illustrative rather than a restrictive sense. It will, however, be evident that additions, subtractions, deletions, and other modifications and changes may be made thereunto without departing from the broader spirit and scope of the inventions as set forth in the claims.

What is claimed is:

1. A tool comprising:
a flexible straightedge, wherein said straightedge is of a predetermined thickness, width and length, and wherein said straightedge has a top horizontal edge, a bottom horizontal edge, and a left vertical edge and a right vertical edge; and,
a leveling unit attached to a surface of said straightedge,
wherein said leveling unit comprises a horizontal level and a vertical level,
wherein said horizontal level is parallel to said top horizontal edge and parallel to said bottom horizontal edge of said straightedge, and wherein said vertical level is parallel to said left vertical edge and parallel to said right vertical edge of said straightedge.

2. The tool of claim 1 wherein said straightedge further comprises measurement indicia on a bottom portion of said straightedge.

3. The tool of claim 1 wherein said straightedge further comprises measurement indicia on a top portion of said straightedge.

4. The tool of claim 1 wherein said straightedge further comprises measurement indicia on a top portion of said straightedge and on a bottom portion of said straightedge.

5. The tool of claim 1 further comprising a first punched hole proximal to said left vertical edge of said straightedge, and a second punched hole proximal to said right vertical edge of said straightedge.

6. The tool of claim 1 further comprising means of keeping said straightedge in a rolled configuration.

7. The tool of claim 2 further comprising a first punched hole proximal to said left vertical edge of said straightedge, and a second punched hole proximal to said right vertical edge of said straightedge.

8. The tool of claim 3 further comprising a first punched hole proximal to said left vertical edge of said straightedge, and a second punched hole proximal to said right vertical edge of said straightedge.

9. The tool of claim 4 further comprising a first punched hole proximal to said left vertical edge of said straightedge, and a second punched hole proximal to said right vertical edge of said straightedge.

10. A tool comprising:
a flexible straightedge, wherein said straightedge is of a predetermined thickness, width and length, and wherein said straightedge has a top portion and a bottom portion; and, a leveling unit attached to a surface of said straightedge.

11. The tool of claim 10 wherein said straightedge further comprises measurement indicia on said top portion of said straightedge.

12. The tool of claim 10 wherein said straightedge further comprises measurement indicia on said bottom portion of said straightedge.

13. The tool of claim 10 wherein said straightedge further comprises measurement indicia on said top portion of said straightedge and on said bottom portion of said straightedge.

14. The tool of claim 10 wherein said straightedge further comprises a first punched hole proximal to a left vertical edge of said straightedge.

15. The tool of claim 10 wherein said straightedge further comprises a second punched hole proximal to a right vertical edge of said straightedge.

16. The tool of claim 10 further comprising means of keeping said straightedge in a rolled configuration.

17. The tool of claim 10 wherein said leveling unit is a bubble-level type leveling unit.

18. The tool of claim 17 wherein said leveling unit comprises a vertical level and a horizontal level.

19. The tool of claim 18 wherein said leveling unit is attached to said straightedge such that said vertical level is parallel to a left vertical edge of said straightedge.

20. The tool of claim 18 wherein said leveling unit is attached to said straightedge such that said horizontal level is parallel to a top horizontal edge of said straightedge.
